(19) United States
(12) Patent Application Publication
(10) Pub. No.: US 2012/0013539 A1
(43) Pub. Date: Jan. 19, 2012

(54) SYSTEMS WITH GESTURE-BASED EDITING OF TABLES

(76) Inventors: Edward P.A. Hogan, Pittsburgh, PA (US); Matthew Lehrian, Pittsburgh, PA (US)

(21) Appl. No.: 12/835,697

(22) Filed: Jul. 13, 2010

(51) Int. Cl. G06F 3/041; G06F 3/033

(52) U.S. Cl. 345/173; 715/863

(57) ABSTRACT

Computing equipment such as devices with touch screen displays and other touch sensitive equipment may be used to display tables of data to a user. The tables of data may contain rows and columns. Touch gestures such as tap and flick gestures may be detected using the touch screen or other touch sensor. In response to a detected tap such as a tap on a row or column header, the computing equipment may select and highlight a corresponding row or column in a displayed table. In response to a flick gesture in a particular direction, the computing equipment may move the selected row or column to a new position within the table. For example, if the user selects a particular column and supplies a right flick gestures, the selected column may be moved to the right edge of a body region in the table.

### BACKGROUND

This relates generally to systems for manipulating data, and, more particularly, to systems in which gestures may be used to manipulate rows and columns of data items in an array.

Electronic devices such as computers and handheld devices are often used to manipulate data. For example, electronic devices may be used to run spreadsheet applications that allow users to manipulate rows and columns of data. Electronic devices may also be used to implement operating systems and other software in which rows and columns are manipulated.

In some electronic devices, touch sensors are used to gather user input. For example, pen-based computers may gather input from a stylus. Tablet computers and other devices with touch screens may receive user input in the form of gestures made with a user's fingertips on a touch screen. Some devices may gather user touch input using a touch pad.

Conventional electronic devices in which data is presented to a user may sometimes allow the data to be manipulated using touch gestures. Such touch gestures may not, however, be practical in many circumstances. For example, conventional gestures may be difficult or impossible to use in an environment in which data is presented in a table with large numbers of rows and columns. Some conventional gestured-based devices may also require the use of undesirably complex and unintuitive gestures. The use of conventional arrangements such as these can lead to editing failures and other problems.

It would therefore be desirable to provide a way in which to address the shortcomings of conventional schemes for manipulating tables of data.

### SUMMARY

Computing equipment may include one or more electronic devices such as tablet computers, computer monitors, cellular telephones, and other electronic equipment. The computing equipment may include touch screen displays and other components with touch sensor arrays. A user may control operation of the computing equipment by supplying user input commands in the form of touch gestures.

Tables of data containing rows and columns may be displayed on a display in the computing equipment. A user may use a tap gesture to select a desired row or column for movement within the table. For example, a user may tap on a row header to select and highlight a desired row or may tap on a column header to select and highlight a desired column.

Gestures may be used to move a selected row or column. For example, a user may use a flick gesture to move a selected row or column. Flick gestures may involve movement of a user's finger or other external object in a particular direction along the surface of a touch screen or other touch sensitive device. A user may, for example, make a right flick gesture by moving a finger horizontally to the right along the surface of a touch screen. Left flick gestures, upwards flick gestures, and downwards flick gestures may also be used.

Selected columns and rows may be moved in the direction of a flick gesture when a flick gesture is detected. For example, if a right flick is detected, a selected column may be moved to the right within a table. If a left flick is detected, a selected column may be moved to the left. An up flick may be used to move a selected row upwards within a table and a down flick may be used to move a selected row downwards within a table. In a table with numerous rows and columns, a flick gesture may be used to move a selected row or column over relatively long distances within the table.

A table may contain a body region having cells that are filled with data. Empty cells may surround the body region. When a row or column is moved, the row or column may be placed along an appropriate edge of the body region. For example, a table may contain a body region that is bordered on the left with several columns of empty cells. When a user selects a column and makes a left flick gesture, the column may be moved to the far left edge of the body region, adjacent to the empty columns. If desired, the column may be flicked to the border of the table (i.e., so that the cells of the empty columns are interposed between the moved column and the table body).

In some situations, a selected row or column may make up an interior portion of a table body region. When this type of row or column is moved, a gap may be created in the table body. The gap may be automatically closed by repositioning the data in the body region. As an example, a column may be moved to the original left edge of a table body region with a tap and left flick. The column entries from the original left-edge of the table body region may be replaced with the column entries from the moved column. The original left-edge column and all other columns up to the gap column may be moved one column to the right, thereby making room for the moved column and filling in the gap that was left behind by the moved column. Column movements to the right and up and down row movements may be handled in the same way.

The tables that are displayed may be associated with application such as spreadsheet applications, music creation applications, other applications, operating system functions, or other software. Gesture recognizer code may be implemented as part of an operating system or as part of an application or other software. Touch data may be processed within an operating system and within applications on the computing equipment using the gesture recognizer code.

Further features of the invention, its nature and various advantages will be more apparent from the accompanying drawings and the following detailed description of the preferred embodiments.

### BRIEF DESCRIPTION OF THE DRAWINGS

FIG. 1 is schematic diagram of an illustrative system in which data may be edited using gestured-based commands in accordance with an embodiment of the present invention.

FIG. 2 is a schematic diagram of illustrative computing equipment that may be used in a system of the type shown in FIG. 1 in accordance with an embodiment of the present invention.

FIG. 3 is a cross-sectional side view of equipment that includes a touch sensor and display structures in accordance with an embodiment of the present invention.

FIG. 4 is a schematic diagram showing code that may be stored and executed on computing equipment such as the computing equipment of FIG. 1 in accordance with an embodiment of the present invention.

FIG. 5 is a schematic diagram showing how touch gesture data may be extracted from touch event data using touch recognition engines in accordance with an embodiment of the present invention.

FIG. 6 is a diagram showing how gesture data may be received and processed by code that is running on computing equipment of the type shown in FIG. 1 and showing how the code may perform associated actions such as updating output and updating column and row position data within a table or other array of data items a database in accordance with an embodiment of the present invention.

FIG. 7 is a graph showing touch data that may be associated with a tap in accordance with an embodiment of the present invention.

FIG. 8 is a graph showing illustrative touch event data that may be associated with a select and drag gesture in accordance with an embodiment of the present invention.

FIG. 9 is a graph showing illustrative touch data that may be associated with a tap and flick gesture in accordance with an embodiment of the present invention.

FIG. 10A is a graph showing illustrative touch data of the type that may be associated with a tap event in accordance with an embodiment of the present invention.

FIG. 10B is a graph showing illustrative touch data of the type that may be associated with a right flick event in accordance with an embodiment of the present invention.

FIG. 10C is a graph showing illustrative touch data of the type that may be associated with a left flick event in accordance with an embodiment of the present invention.

FIG. 10D is a graph showing illustrative touch data of the type that may be associated with an upward flick in accordance with an embodiment of the present invention.

FIG. 10E is a graph showing illustrative touch data of the type that may be associated with a downward flick in accordance with an embodiment of the present invention.

FIG. 11 shows an illustrative table of data that may be presented to a user of computing equipment in accordance with an embodiment of the present invention.

FIG. 12 shows how a column of data may be selected and highlighted using a tap gesture and shows how a flick gesture may supplied to move the column of data in accordance with an embodiment of the present invention.

FIG. 13 shows how the column of data that was selected in FIG. 12 may be moved to the right edge of a body of table entries following processing of the flick gesture in accordance with the present invention.

FIG. 14 shows an illustrative table of data that contains unfilled entries to the left of a body region in accordance with an embodiment of the present invention.

FIG. 15 shows how a column of data may be highlighted using a tap gesture and shows how a left flick gesture may be used to move the column of data to the left in accordance with an embodiment of the present invention.

FIG. 16 shows how the column of data that was moved to the left in FIG. 15 may be placed along the left edge of a table body region in accordance with the present invention.

FIG. 17 is a table showing how the selected column of data in FIG. 15 may be moved to the left edge of the table in response to the left flick gesture so that empty cells are interposed between the selected column and the table body region in accordance with an embodiment of the present invention.

FIG. 18 is a diagram of an illustrative table that contains data entries represented by numbers and that contains user-supplied row and column header information in accordance with an embodiment of the present invention.

FIG. 19 shows how a tap gesture on a column header may be used to select one of the columns of the table of FIG. 18 and shows how a left flick gesture may be used to edit the position of the selected column in accordance with an embodiment of the present invention.

FIG. 20 shows how the selected column of FIG. 19 may be moved to the left of the data entries while remaining to the right of the user-supplied row headers in the table in accordance with an embodiment of the present invention.

FIG. 21 is a diagram of an illustrative array of data organized into a table in which each row corresponds to a separate data item and each column in that row contains a different corresponding attribute for that data item in accordance with an embodiment of the present invention.

FIG. 22 is a diagram showing how a tap gesture on a column header and a flick gesture may be used to select and move a desired column of data in the table of FIG. 21 in accordance with an embodiment of the present invention.

FIG. 23 is a diagram of the table of FIG. 21 after column of data has been moved in response to the tap and flick gestures of FIG. 22 in accordance with an embodiment of the present invention.

FIG. 24 is a diagram of an illustrative screen of music track data that may be presented by an application such as a music creation application showing how track data may be presented in a table of rows and columns in accordance with an embodiment of the present invention.

FIG. 25 is a diagram showing how a tap gesture on a row header such as a track number may be used to select a row of table data such as a row of the music track data in the table of FIG. 24 and showing how a flick gesture may be used to move the selected row within the table in accordance with the present invention.

FIG. 26 is a diagram showing how the selected row of FIG. 25 may be moved to the top row of the table in response to receipt of the upwards flick gesture of FIG. 25 in accordance with an embodiment of the present invention.

FIG. 27 is a diagram showing how the selected row of FIG. 25 may be moved to the bottom row of the table in response to receipt of a downwards flick gesture in accordance with an embodiment of the present invention.

FIG. 28 is a flow chart of illustrative steps involved in using a system of the type shown in FIG. 1 to edit tables having columns and rows of data in response to user-supplied touch gestures such as tap and flick gestures in accordance with an embodiment of the present invention.

### DETAILED DESCRIPTION

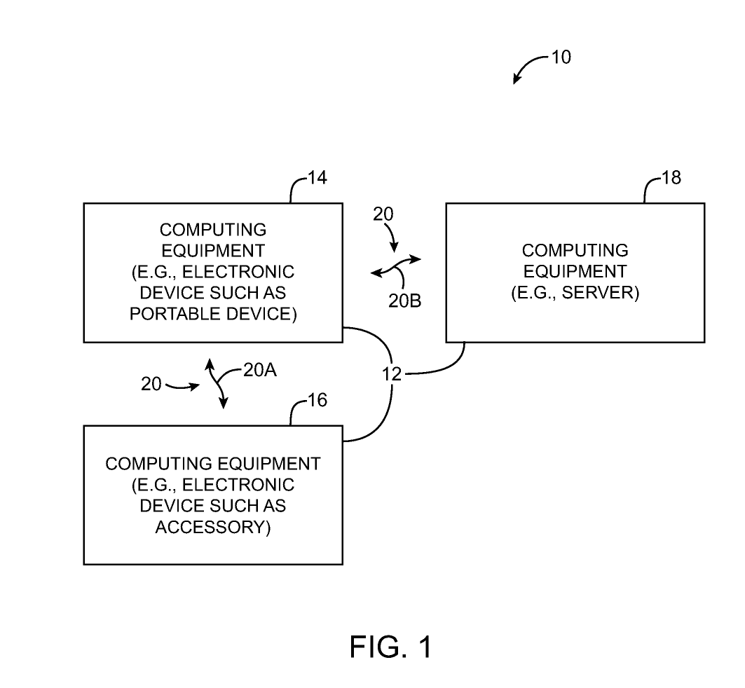

An illustrative system of the type that may be used to manipulate tables containing rows and columns of data is shown in FIG. 1. As shown in FIG. 1, system 10 may include computing equipment 12. Computing equipment 12 may include one or more pieces of electronic equipment such as equipment 14, 16, and 18. Equipment 14, 16, and 18 may be linked using one or more communications paths 20.

Computing equipment 12 may include one or more electronic devices such as desktop computers, servers, mainframes, workstations, network attached storage units, laptop computers, tablet computers, cellular telephones, media players, other handheld and portable electronic devices, smaller devices such as wrist-watch devices, pendant devices, headphone and earpiece devices, other wearable and miniature devices, accessories such as mice, touch pads, or mice with integrated touch pads, joysticks, touch-sensitive monitors, or other electronic equipment.

Software may run on one or more pieces of computing equipment 12. In some situations, most or all of the software used to implement table manipulation functions may run on a single platform (e.g., a tablet computer with a touch screen). In other situations, some of the software runs locally (e.g., as a client implemented on a laptop), whereas other software runs remotely (e.g., using a server implemented on a remote computer or group of computers). When accessories such as accessory touch pads are used in system 10, some equipment 12 may be used to gather touch input, other equipment 12 may be used to run a local portion of a program, and yet other equipment 12 may be used to run a remote portion of a program. Other configurations such as configurations involving four or more different pieces of computing equipment 14 may be used if desired.

With one illustrative scenario, computing equipment 14 of system 10 may be based on an electronic device such as a computer (e.g., a desktop computer, a laptop computer or other portable computer, a handheld device such as a cellular telephone with computing capabilities, etc.). In this type of scenario, computing equipment 16 may be, for example, an optional electronic device such as a pointing device or other user input accessory (e.g., a touch pad, a touch screen monitor, etc.). Computing equipment 14 (e.g., an electronic device) and computing equipment 16 (e.g., an accessory) may communicate over communications path 20A. Path 20A may be a wired path (e.g., a Universal Serial Bus path or FireWire path) or a wireless path (e.g., a local area network path such as an IEEE 802.11 path or a Bluetooth® path). Computing equipment 14 may interact with computing equipment 18 over communications path 20B. Path 20B may include local wired paths (e.g., Ethernet paths), wired paths that pass through local area networks and wide area networks such as the internet, and wireless paths such as cellular telephone paths and wireless local area network paths (as an example). Computing equipment 18 may be a remote server or a peer device (i.e., a device similar or identical to computing equipment 14). Servers may be implemented using one or more computers and may be implemented using geographically distributed or localized resources.

In an arrangement of the type in which equipment 16 is a user input accessory such as an accessory that includes a touch sensor array, equipment 14 is a device such as a tablet computer, cellular telephone, or a desktop or laptop computer with a touch sensitive screen, and equipment 18 is a server, user input commands may be received using equipment 16 and equipment 14. For example, a user may supply a touch-based gesture to a touch pad or touch screen associated with accessory 16 or may supply a touch gesture to a touch pad or touch screen associated with equipment 14. Gesture recognition functions may be implemented on equipment 16 (e.g., using processing circuitry in equipment 16), on equipment 14 (e.g., using processing circuitry in equipment 14), and/or in equipment 18 (e.g., using processing circuitry in equipment 18). Software for handling database management functions and for supporting the display and editing of a table of data may be implemented using equipment 14 and/or equipment 18 (as an example).

Subsets of equipment 12 may also be used to handle user input processing (e.g., touch data processing) and table manipulation functions. For example, equipment 18 and communications link 20B need not be used. When equipment 18 and path 20B are not used, table storage and editing functions may be handled using equipment 14. User input processing may be handled exclusively by equipment 14 (e.g., using an integrated touch pad or touch screen in equipment 14) or may be handled using accessory 16 (e.g., using a touch sensitive accessory to gather touch data from a touch sensor array). If desired, additional computing equipment (e.g., storage for a database or a supplemental processor) may communicate with computing equipment 12 of FIG. 1 using communications links 20 (e.g., wired or wireless links).

Computing equipment 12 may include storage and processing circuitry. The storage of computing equipment 12 may be used to store software code such as instructions for software that handles tasks associated with monitoring and interpreting touch data and other user input. The storage of computing equipment 12 may also be used to store software code such as instructions for software that handles database management functions (e.g., opening and closing files, maintaining information on the data within various files, etc). Content such as table data and data structures that maintain information on the locations of data within tables (e.g., row and column position information) may also be maintained in storage. The processing capabilities of system 10 may be used to gather and process user input such as touch gestures. These processing capabilities may also be used in determining how to display information for a user on a display, how to print information on a printer in system 10, etc. Data manipulation functions such as functions related to adding, deleting, moving, and otherwise editing rows and columns of data in a table may also be supported by the processing circuitry of equipment 12.

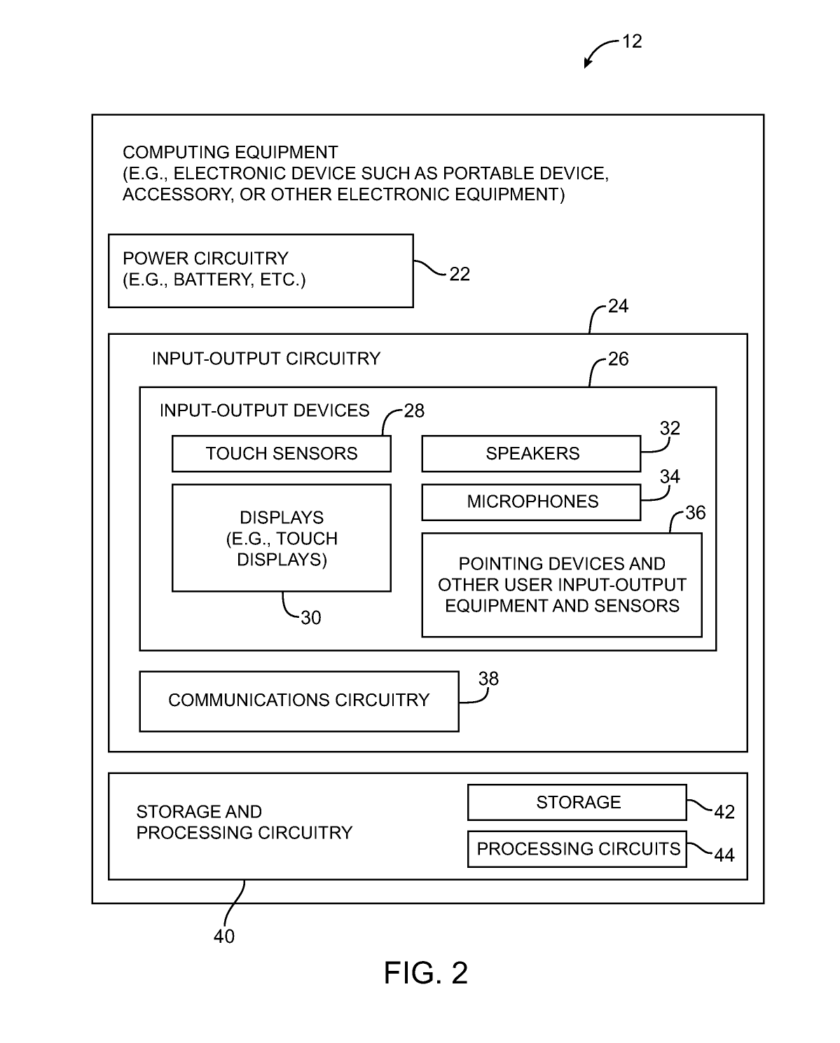

Illustrative computing equipment of the type that may be used for some or all of equipment 14, 16, and 18 of FIG. 1 is shown in FIG. 2. As shown in FIG. 2, computing equipment 12 may include power circuitry 22. Power circuitry 22 may include a battery (e.g., for battery powered devices such a cellular telephones, tablet computers, laptop computers, and other portable devices). Power circuitry 22 may also include power management circuitry that regulates the distribution of power from the battery or other power source. The power management circuit may be used to implement functions such as sleep-wake functions, voltage regulation functions, etc.

Input-output circuitry 24 may be used by equipment 12 to transmit and receive data. For example, in configurations in which the components of FIG. 2 are being used to implement equipment 14 of FIG. 1, input-output circuitry 24 may receive data from equipment 16 over path 20A and may supply data from input-output circuitry 24 to equipment 18 over path 20B.

Input-output circuitry 24 may include input-output devices 26. Devices 26 may include, for example, a display such as display 30. Display 30 may be a touch screen (touch sensor display) that incorporates an array of touch sensors. Display 30 may include image pixels formed from light-emitting diodes (LEDs), organic LEDs (OLEDs), plasma cells, electronic ink elements, liquid crystal display (LCD) components, or other suitable image pixel structures. A cover layer such as a layer of cover glass member may cover the surface of display 30. Display 30 may be mounted in the same housing as other device components or may be mounted in an external housing.

If desired, input-output circuitry 24 may include touch sensors 28. Touch sensors 28 may be included in a display (i.e., touch sensors 28 may serve as a part of touch sensitive display 30 of FIG. 2) or may be provided using a separate touch sensitive structure such as a touch pad (e.g., a planar touch pad or a touch pad surface that is integrated on a planar or curved portion of a mouse or other electronic device).

Touch sensor 28 and the touch sensor in display 30 may be implemented using arrays of touch sensors (i.e., a two-dimensional array of individual touch sensor elements combined to provide a two-dimensional touch event sensing capability). Touch sensor circuitry in input-output circuitry 24 (e.g., touch sensor arrays in touch sensors 28 and/or touch screen displays 30) may be implemented using capacitive touch sensors or touch sensors formed using other touch technologies (e.g., resistive touch sensors, acoustic touch sensors, optical touch sensors, piezoelectric touch sensors or other force sensors, or other types of touch sensors). Touch sensors that are based on capacitive touch sensors are sometimes described herein as an example. This is, however, merely illustrative. Equipment 12 may include any suitable touch sensors.

Input-output devices 26 may use touch sensors to gather touch data from a user. A user may supply touch data to equipment 12 by placing a finger or other suitable object (i.e., a stylus) in the vicinity of the touch sensors. With some touch technologies, actual contact or pressure on the outermost surface of the touch sensor device is required. In capacitive touch sensor arrangements, actual physical pressure on the touch sensor surface need not always be provided, because capacitance changes can be detected at a distance (e.g., through air). Regardless of whether or not physical contact is made between the user's finger or other eternal object and the outer surface of the touch screen, touch pad, or other touch sensitive component, user input that is detected using a touch sensor array is generally referred to as touch input, touch data, touch sensor contact data, etc.

Input-output devices 26 may include components such as speakers 32, microphones 34, switches, pointing devices, sensors, and other input-output equipment 36. Speakers 32 may produce audible output for a user. Microphones 34 may be used to receive voice commands from a user. Equipment 36 may include mice, trackballs, keyboards, keypads, buttons, and other pointing devices and data entry devices. Equipment 36 may also include output devices such as status indicator light-emitting diodes, buzzers, etc. Sensors in equipment 36 may include proximity sensors, ambient light sensors, thermal sensors, accelerometers, gyroscopes, magnetic sensors, infrared sensors, etc. If desired, input-output devices 26 may include other user interface devices, data port devices, audio jacks and other audio port components, digital data port devices, etc.

Communications circuitry 38 may include wired and wireless communications circuitry that is used to support communications over communications paths such as communications paths 20 of FIG. 1. Communications circuitry 38 may include wireless communications circuitry that forms remote and local wireless links. Communications circuitry 38 may handle any suitable wireless communications bands of interest. For example, communications circuitry 38 may handle wireless local area network bands such as the IEEE 802.11 bands at 2.4 GHz and 5 GHz, the Bluetooth band at 2.4 GHz, cellular telephone bands, 60 GHz signals, radio and television signals, satellite positioning system signals such as Global Positioning System (GPS) signals, etc.

Computing equipment 12 may include storage and processing circuitry 40. Storage and processing circuitry 40 may include storage 42. Storage 42 may include hard disk drive storage, nonvolatile memory (e.g., flash memory or other electrically-programmable-read-only memory configured to form a solid state drive), volatile memory (e.g., static or dynamic random-access-memory), etc. Processing circuitry 44 in storage and processing circuitry 40 may be used to control the operation of equipment 12. This processing circuitry may be based on one or more microprocessors, microcontrollers, digital signal processors, application specific integrated circuits, etc.

The resources associated with the components of computing equipment 12 in FIG. 2 need not be mutually exclusive. For example, storage and processing circuitry 40 may include circuitry from the other components of equipment 12. Some of the processing circuitry in storage and processing circuitry 40 may, for example, reside in touch sensor processors associated with touch sensors 28 (including portions of touch sensors that are associated with touch sensor displays such as touch displays 30). As another example, storage may be implemented both as stand-alone memory chips and as registers and other parts of processors and application specific integrated circuits. There may be, for example, memory and processing circuitry 40 that is associated with communications circuitry 38.

Storage and processing circuitry 40 may be used to run software on equipment 12 such as touch sensor processing code, productivity applications such as spreadsheet applications, word processing applications, presentation applications, and database applications, software for internet browsing applications, voice-over-internet-protocol (VoIP) telephone call applications, email applications, media playback applications, operating system functions, etc. Storage and processing circuitry 40 may also be used to run applications such as video editing applications, music creation applications (i.e., music production software that allows users to capture audio tracks, record tracks of virtual instruments, etc.), photographic image editing software, graphics animation software, etc. To support interactions with external equipment (e.g., using communications paths 20), storage and processing circuitry 40 may be used in implementing communications protocols. Communications protocols that may be implemented using storage and processing circuitry 40 include internet protocols, wireless local area network protocols (e.g., IEEE 802.11 protocols—sometimes referred to as WiFi®), protocols for other short-range wireless communications links such as the Bluetooth® protocol, cellular telephone protocols, etc.

A user of computing equipment 14 may interact with computing equipment 14 using any suitable user input interface. For example, a user may supply user input commands using a pointing device such as a mouse or trackball and may receive output through a display, speakers, and printer (as an example). A user may also supply input using touch commands. Touch-based commands, which are sometimes referred to herein as gestures, may be made using a touch sensor array (see, e.g., touch sensors 28 and touch screens 30 in the example of FIG. 2). Touch gestures may be used as the exclusive mode of user input for equipment 12 (e.g., in a device whose only user input interface is a touch screen) or may be used in conjunction with supplemental user input devices (e.g., in a device that contains buttons or a keyboard in addition to a touch sensor array).

Touch commands (gestures) may be gathered using a single touch element (e.g., a touch sensitive button), a one-dimensional touch sensor array (e.g., a row of adjacent touch sensitive buttons), or a two-dimensional array of touch sensitive elements (e.g., a two-dimensional array of capacitive touch sensor electrodes or other touch sensor pads). Two-dimensional touch sensor arrays allow for gestures such as swipes that have particular directions in two dimensions (e.g., right, left, up, down). Touch sensors may, if desired, be provided with multitouch capabilities, so that more than one simultaneous contact with the touch sensor can be detected and processed. With multitouch capable touch sensors, additional gestures may be recognized such as multifinger swipes, pinch commands, etc.

Touch sensors such as two-dimensional sensors are sometimes described herein as an example. This is, however, merely illustrative. Computing equipment 12 may use other types of touch technology to receive user input if desired.

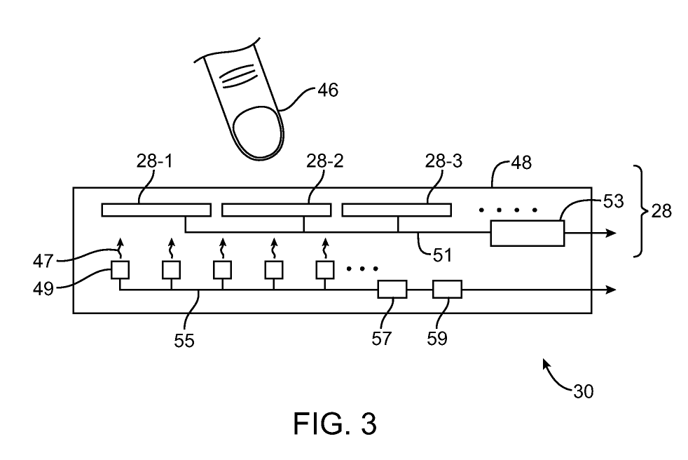

A cross-sectional side view of a touch sensor that is receiving user input is shown in FIG. 3. As shown in the example of FIG. 3, touch sensor 28 may have an array of touch sensor elements such as elements 28-1, 28-2, and 28-3 (e.g., a two-dimensional array of elements in rows and columns across the surface of a touch pad or touch screen). A user may place an external object such as finger 46 in close proximity of surface 48 of sensor 28 (e.g., within a couple of millimeters or less, within a millimeter or less, in direct contact with surface 48, etc.). When touching sensor 28 in this way, the sensor elements that are nearest to object 46 can detect the presence of object 46. For example, if sensor elements 28-1, 28-2, 28-3, . . . are capacitive sensor electrodes, a change in capacitance can be measured on the electrode or electrodes in the immediate vicinity of the location on surface 48 that has been touched by external object 46. In some situations, the pitch of the sensor elements (e.g., the capacitor electrodes) is sufficiently fine that more than one electrode registers a touch signal. When multiple signals are received, touch sensor processing circuitry (e.g., processing circuitry in storage and processing circuitry 40 of FIG. 2) can perform interpolation operations in two dimensions to determine a single point of contact between the external object and the sensor.

Touch sensor electrodes (e.g., electrodes for implementing elements 28-1, 28-2, 28-3 . . . ) may be formed from transparent conductors such as conductors made of indium tin oxide or other transparent conductive materials. Touch sensor circuitry 53 (e.g., part of storage and processing circuitry 40 of FIG. 2) may be coupled to sensor electrodes using paths 51 and may be used in processing touch signals from the touch sensor elements. An array (e.g., a two-dimensional array) of image display pixels such as pixels 49 may be used to emit images for a user (see, e.g., individual light rays 47 in FIG. 3). Display memory 59 may be provided with image data from an application, operating system, or other code on computing equipment 12. Display drivers 57 (e.g., one or more image pixel display integrated circuits) may display the image data stored in memory 59 by driving image pixel array 49 over paths 55. Display driver circuitry 57 and display storage 59 may be considered to form part of a display (e.g., display 30) and/or part of storage and processing circuitry 40 (FIG. 2). A touch screen display (e.g., display 30 of FIG. 3) may use touch sensor array 28 to gather user touch input and may use display structures such as image pixels 49, display driver circuitry 57, and display storage 59 to display output for a user.

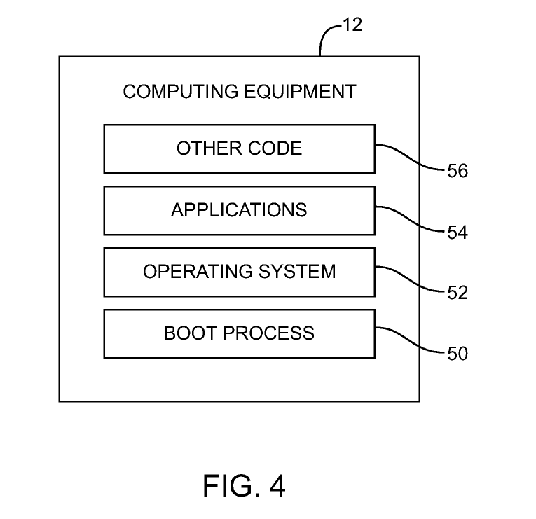

FIG. 4 is a diagram of computing equipment 12 of FIG. 1 showing code that may be implemented on computing equipment 12. The code on computing equipment 12 may include firmware, application software, operating system instructions, code that is localized on a single piece of equipment, code that operates over a distributed group of computers or is otherwise executed on different collections of storage and processing circuits, etc. In a typical arrangement of the type shown in FIG. 4, some of the code on computing equipment 12 includes boot process code 50. Boot code 50 may be used during boot operations (e.g., when equipment 12 is booting up from a powered-down state). Operating system code 52 may be used to perform functions such as creating an interface between computing equipment 12 and peripherals, supporting interactions between components within computing equipment 12, monitoring computer performance, executing maintenance operations, providing libraries of drivers and other collections of functions that may be used by operating system components and application software during operation of computing equipment 12, supporting file browser functions, running diagnostic and security components, etc.

Applications 54 may include productivity applications such as word processing applications, email applications, presentation applications, spreadsheet applications, and database applications. Applications 54 may also include communications applications, media creation applications, media playback applications, games, web browsing application, etc. Some of these applications may run as stand-alone programs, others may be provided as part of a suite of interconnected programs. Applications 54 may also be implemented using a client-server architecture or other distributed computing architecture (e.g., a parallel processing architecture).

Computing equipment 12 may also have other code 56 (e.g., add-on processes that are called by applications 54 or operating system 52, plug-ins for a web browser or other application, etc.).

Code such as code 50, 52, 54, and 56 may be used to handle user input commands (e.g., gestures and non-gesture input) and can perform corresponding actions. For example, the code of FIG. 4 may be configured to receive touch input. In response to the touch input, the code of FIG. 4 may be configured to perform processing functions and output functions. Processing functions may include evaluating mathematical functions, moving data items within a group of items, updating databases, presenting data items to a user on a display, printer, or other output device, sending emails or other messages containing output from a process, etc.

Raw touch input (e.g., signals such as capacitance change signals measured using a capacitive touch sensor or other such touch sensor array data) may be processed using storage and processing circuitry 40 (e.g., using a touch sensor chip that is associated with a touch pad or touch screen, using a combination of dedicated touch processing chips and general purpose processors, using local and remote processors, or using other storage and processing circuitry).

Gestures such as taps, swipes, flicks, multitouch commands, and other touch input may be recognized and converted into gesture data by processing raw touch data. As an example, a set of individual touch contact points that are detected within a given radius on a touch screen and that occur within a given time period may be recognized as a tap gesture or as a tap portion of a more complex gesture. Gesture data may be represented using different (e.g., more efficient) data structures than raw touch data. For example, ten points of localized raw contact data may be converted into a single tap gesture. Code 50, 52, 54, and 56 of FIG. 4 may use raw touch data, processed touch data, recognized gestures, other user input, or combinations of these types of input as input commands during operation of computing equipment 12.

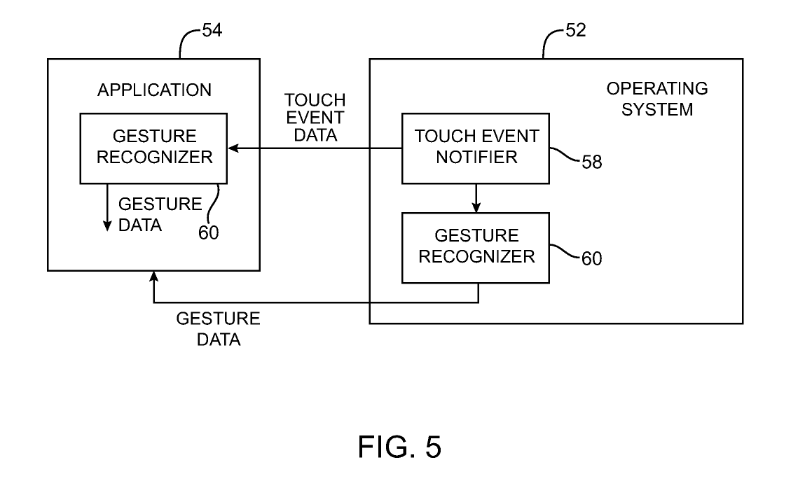

If desired, touch data (e.g., raw touch data) may be gathered using a software component such as touch event notifier 58 of FIG. 5. Touch event notifier 58 may be implemented as part of operating system 52 or as other code executed on computing equipment 12. Touch event notifier 58 may provide touch event data (e.g., information on contact locations with respect to orthogonal X and Y dimensions and optional contact time information) to gesture recognition code such as one or more gesture recognizers 60. Operating system 52 may include a gesture recognizer that processes touch event data from touch event notifier 58 and that provides corresponding gesture data as an output. An application such as application 54 or other software on computing equipment 12 may also include a gesture recognizer. As shown in FIG. 5, for example, application 54 may perform gesture recognition using gesture recognizer 60 to produce corresponding gesture data.

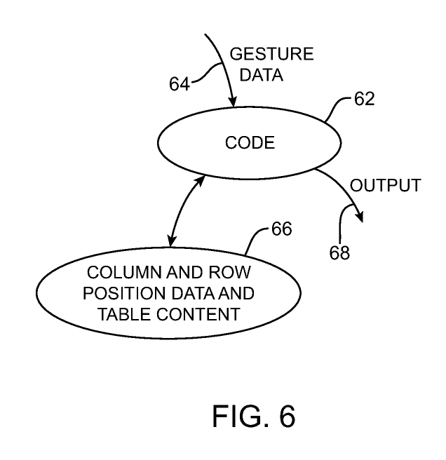

Gesture data that is generated by gesture recognizer 60 in application 54 or gesture recognizer 60 in operating system 52 or gesture data that is produced using other gesture recognition resources in computing equipment 12 may be used in controlling the operation of application 54, operating system 52, and other code (see, e.g., the code of FIG. 4). For example, gesture recognizer code 60 may be used in detecting tap gesture activity from a user to select rows or columns in a table and may be used in detecting flick gestures to move the rows or columns within the table. The use of gesture data from gesture recognizer code 60 of FIG. 5 is shown in FIG. 6. As shown in FIG. 6, code 62 (e.g., code 50, code 52, code 54, and/or code 56 of FIG. 4) may receive gesture data 64. Code 62 may take suitable action in response to various gestures represented by the gesture data. For example, as shown in FIG. 6, code 62 may take actions related to manipulating stored content 66 and in manipulating output 68. Code 62 may, for example, reposition rows and columns of data 66 within a table or other data structure that is stored in storage 42. These repositioning operations may involve, for example, updating pointers or list entries in data structures that are stored in a database (e.g., data 66 stored in storage 42). The updated data may be part of a local database maintained on the same device that contains the touch sensor or may be a remote database at a server. When the database is maintained remotely, a client program (e.g., an application or other code) may use a local (or associated) touch screen or other touch sensor to obtain gestures and may send corresponding commands to a remote server over a communications network that direct the remote server to update a database at the remote server to account for the new row and column positions in the table. Pointers or other data structures may be used to maintain state information that represents the current state of a table or other data structure, and may support table data operations in local or remote storage 42 such as operations to create, delete, save, and edit rows and columns of data and other data 66.

In addition to performing operations on data in a database (e.g., in addition to manipulating data structures that include row and column position information, table cell entries, and other content 66 stored in storage 42 of FIG. 2), code 62 may control the presentation of output to a user of computing equipment 12, as indicated by output 68 of FIG. 6. For example, code 62 may be configured to print output for a user on a printer in computing equipment 12. Code 62 may also be configured to display output for a user on a display in computing equipment 12 (e.g., by continuously updating display memory in storage and processing circuitry 40, the display driver integrated circuits in display 30, and associated pixel array portions of display 30). If desired, code 62 may be configured to transmit a message containing output for a user using communications circuitry in computing equipment 12, may convey output to a remote display or computer, or may otherwise produce output 68.

In a typical scenario, a user may interact with data that is displayed on a display screen in real time. Using touch gestures (gesture data 64), code 62 may be informed of a user's commands for manipulating the content. The manipulated content (e.g., content 66) may be modified in response to the user's commands by code 62. Code 62 may also display modified output 68 on a display. If, for example, a user supplies computing equipment 12 with instructions to select and move a particular row or column of a table, code 62 may select the desired row or column, may highlight the selected row or column to provide visual feedback to the user, and may animate movement of the row or column or otherwise present a visual representation of movement of the selected row or column to the user. Once movement is complete, the selected row or column may be presented in an appropriate table location and data structures 66 can be updated accordingly.

In general, computing equipment 12 may be controlled using any suitable gestures or combination of gestures. Examples of gestures include taps, double taps, triple taps, quadruple taps, taps that include more than four taps in succession and/or multiple touch locations, single-touch (single-finger) swipes, double-touch (double-finger) swipes, triple-touch (triple-finger) swipes, swipes involving more than three touch points, press and hold gestures, inwards (contracting) pinches, outwards (expanding) pinches, flicks, holds, hold and flicks, etc. Some of these gestures may require fewer movements on the part of a user and may use less battery power within battery-powered computing equipment 12. For example, use of a single tap (i.e., a tap gesture that contains only one tap) and single flick gesture to select and move a row or column in a table may help minimize gesture complexity and, because this type of gesture is relatively intuitive and straightforward and can achieve row or column movement quickly even in tables with large numbers of rows and columns. This may reduce the amount of time computing equipment 12 takes to interpret and act on the gesture, thereby reducing power consumption requirements and burden on the user.

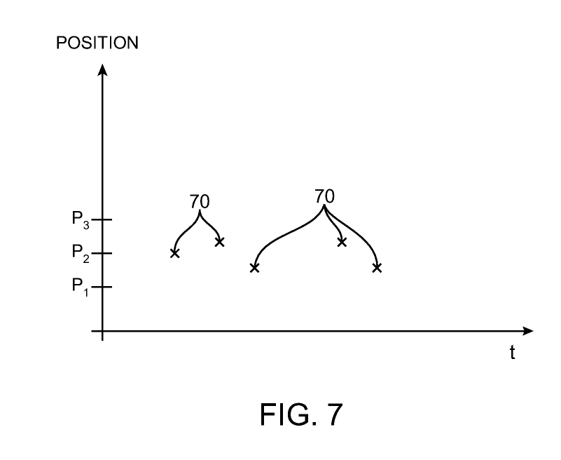

FIG. 7 is a graph showing measured position (plotted in one dimension for clarity in the FIG. 7 example) versus time as a user's finger or other external object is in contact with a touch sensor. As shown in FIG. 7, touch sensor arrays typically gather touch data in the form of a series of discrete touch data points 70, each of which corresponds to a unique position of the user's finger or other external object on the touch sensor. In situations in which the external object is moving, a different respective time will be associated with each touch event.

In the example of FIG. 7, the user is not moving the external object significantly, so touch points do not vary significantly from location P2 as a function of time (i.e., the position of the user's touch is bounded between minimum position P1 and maximum position P3). Provided that positions P1 and P3 are sufficiently close to position P2, gesture recognizer 60 will interpret touch event of the type shown in FIG. 7 as a tap. A tap gesture may be used, for example, to select an item of interest on a display.

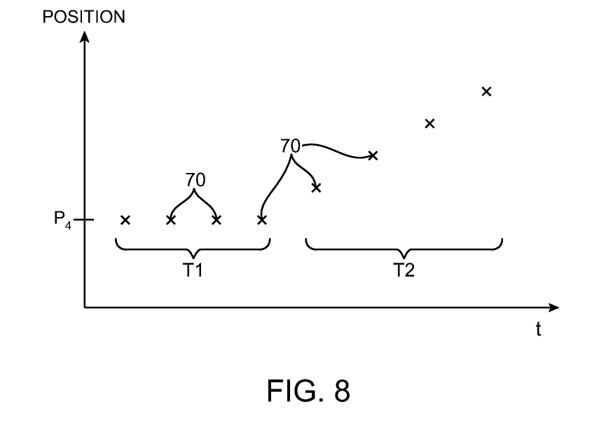

The type of touch data that may be generated during a typical swipe gesture is shown in FIG. 8. Initially (e.g., during time period T1) a user may place an external object at position P4. During time period T2, the user may move the external object across the display (e.g., at a slow to moderate speed). Time periods T1 and T2 are contiguous, because there is no intervening gap in touch contact between periods T1 and T2 (i.e., the initial touching activity and the swiping motions of FIG. 8 may be considered to form part of a unitary swipe operation). After time period T2, touch events 70 cease, because the user in this example has removed the external object from the touch sensor.

In a flick gesture, there is typically no initial stationary touch event (i.e., there is no stationary contact in period T1) and the user may move the external object across the touch sensor more rapidly than in a swipe gesture. Flick gestures may be made in conjunction with other gestures to create more complex gestures. For example, a tap and flick gesture may be used to select an item and perform an action on that item.

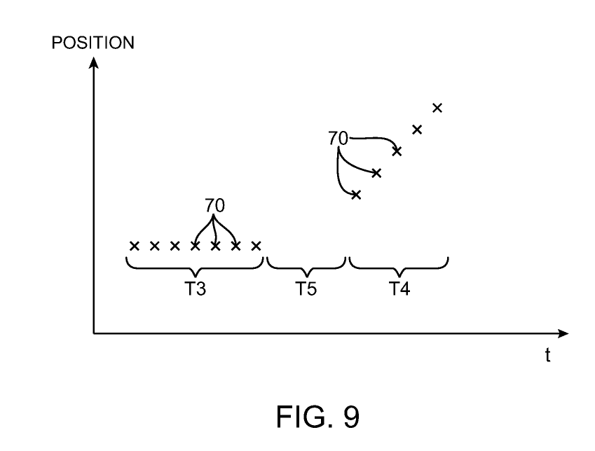

The graph of FIG. 9 shows the type of data that may be associated with a tap and flick gesture. Tap data may be produced during time period T3 and flick data may be produced during time period T4. As shown in FIG. 9, an illustrative tap gesture may be associated with a series of measured touch data points 70 (i.e., a series of contacts 70 that are detected within a fairly localized portion of the touch sensor). A flick gesture (or the flick gesture portion of a tap and flick gesture) may be associated with a series of measured touch data points 70 that correspond to fairly rapid and possibly accelerating movement of a finger or other object across the touch sensor array. A velocity threshold (and, if desired, an acceleration threshold and/or a total gesture time threshold) may be used to help discriminate swipes from flicks. Tap and flick gestures of the type shown in FIG. 9 can also be differentiated from swipes of the type shown in FIG. 8 based at least partly on the presence of a gap between tap period T3 and flick period T4 (i.e., period T5, which is devoid of touch events, indicating that the user has removed the external object from the touch sensor during period T5).

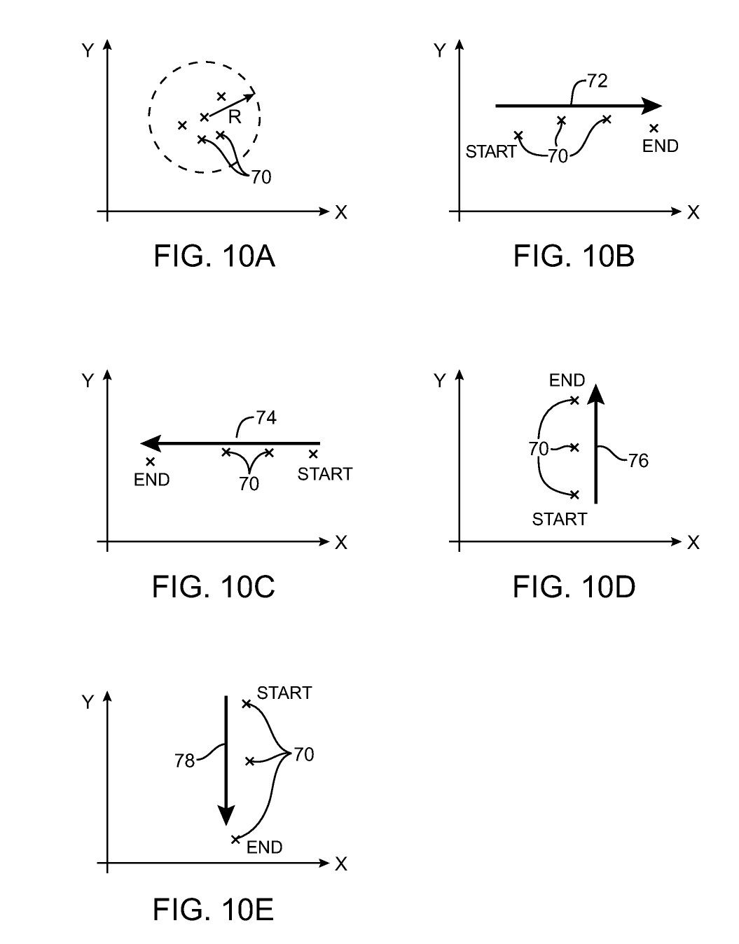

FIGS. 10A, 10B, 10C, 10D, 10E, and 10F are two-dimensional graphs showing the positions (relative to orthogonal lateral touch sensor array dimensions X and Y) of illustrative sequences of touch sensor contacts 70 that may be associated with various types of gestures. The gestures of FIGS. 10A, 10B, 10C, 10D, 10E, and 10F may be used individually or in any combination. Gesture recognizer code 60 may analyze the raw touch sensor data points (sometimes referred to as touch contacts or touch events) to generate gesture data (i.e., recognized gestures).

FIG. 10A shows how a sequence of touch sensor contacts that are localized within a given distance (e.g., a radius R from an initial or central point) may be interpreted as a tap gesture. The sequence of touch sensor data points 70 in FIG. 10B corresponds to illustrative right flick gesture 72. FIG. 10C shows data points 70 corresponding to illustrative left flick gesture 74. FIG. 10D shows an illustrative set of touch data that corresponds to upwards flick 76. Touch data corresponding to illustrative downwards flick 78 is shown in FIG. 10E.

If desired, tap and flick gestures may be supplied by a user (e.g., using a tap of the type shown in FIG. 10A followed by one of the flick gestures of FIGS. 10B, 10C, 10D, and 10E).

Touch input such as tap and flick gestures and other gestures may be used in controlling the code of FIG. 4. For example, tap and flick gestures may be used in manipulating columns and rows of data in a table (sometimes also referred to as a list or array of data).

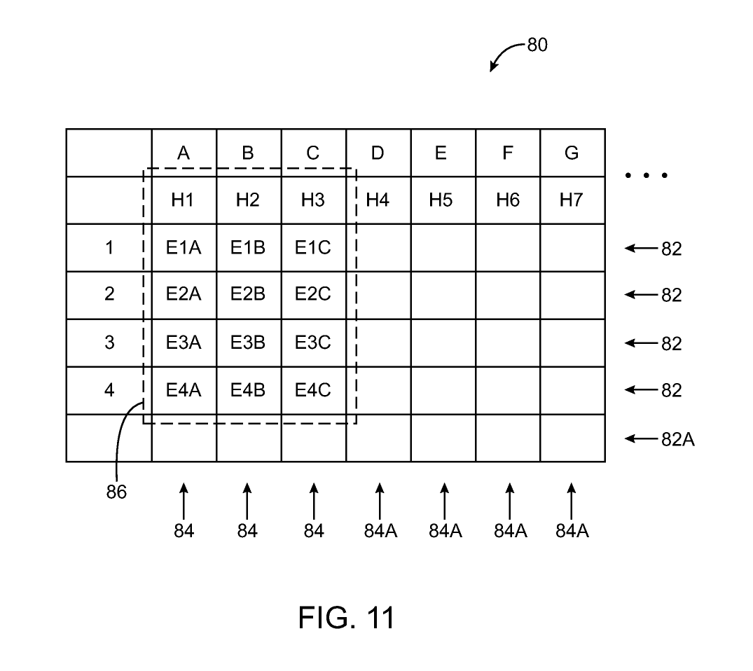

Tables of data elements may be produced by the code of FIG. 4 during operation of computing equipment 12. For example, application code such as a spreadsheet application or word processing application or other such application may display a table of cells. Each cell may contain a string, number, formula, or other information. FIG. 11 shows an illustrative table of the type that may be presented using the code of FIG. 4 running on computing equipment 12. As shown in FIG. 11, table 80 may contain rows 82 and columns 84. Some of the rows (e.g., row 82A in the example of FIG. 11) and some of the columns (e.g., columns 84A in the example of FIG. 11) may contain empty cells. Other cells (i.e., the cells in table body region 86) may contain data and may therefore not be empty.

A user who desires to move a row or column in table 80 may select a row or column of data to be moved using a gesture such as a tap gesture. The tap gesture may be followed by a flick gesture. The direction of the flick gesture may control the location to which the selected row or column of data is moved.

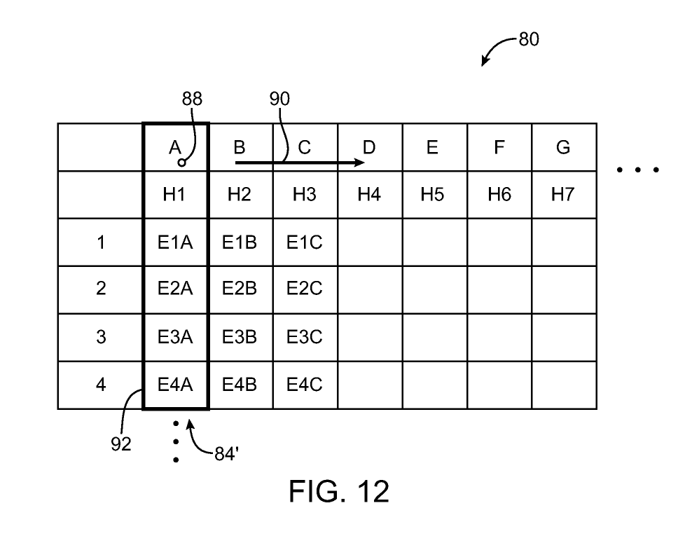

Consider, as an example, the scenario depicted in FIG. 12. In the FIG. 12 example, a user has made a tap gesture on the “A” label at the top of the first column in the body of table 80 (i.e., at the top of column 84′). The “A” label forms a type of column header. When the column header is tapped (e.g., as indicated by tap 88 in FIG. 12), column 84′ may be selected.

If desired, a column (or a row or other selected portion) in table 80 that has been selected may be highlighted to present visual feedback to the user. Any suitable highlighting scheme may be used in table 80 if desired. Examples of highlighting arrangements that may be used include arrangements in which selected cells are presented in a different color, with a different color intensity, with a different hue, with a boarder, with cross-hatching, with animated effects, etc. In the FIG. 12 example, the highlighting of column 88 by the code running on computing equipment 12 is indicated by boarder 92. This is merely illustrative. Any suitable visual indicator may be used to indicate to a user which column (or row) of table 80 has been selected. Moreover, it is not necessary to select rows and columns by tapping on headers. If desired, computing equipment 12 can be configured to select rows and columns in response to taps on other portions of a row or column.

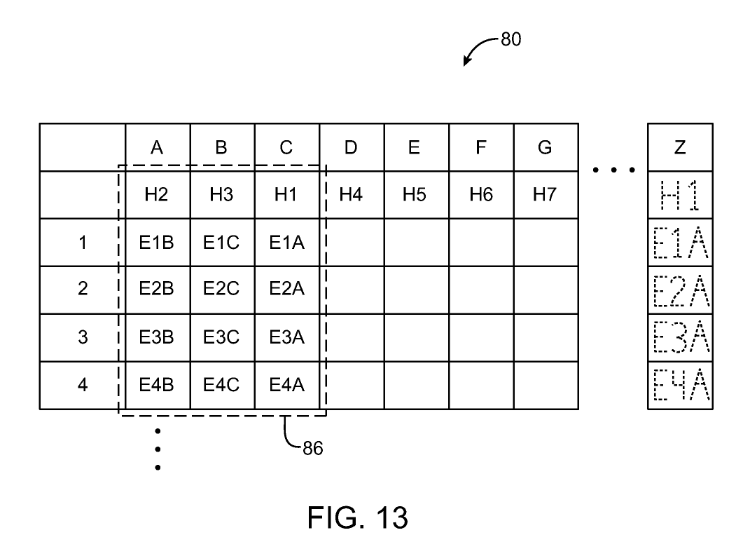

Upon selecting a column to be moved using tap 88, the user can make flick gesture 90 on the touch sensor array (e.g., a right flick). Gesture recognizer 60 can recognize that a tap and flick sequence has occurred and can provide gesture data to an application or other code on computing equipment 12. In response, the selected column (i.e., column 84′) can be highlighted and moved to the far right of the body region, while the remaining columns can each be moved one column to the left to ensure that the position of the body region of table 80 is not changed. The resulting configuration of table 80 following the tap and right flick gesture of FIG. 12 is shown in FIG. 13. If desired, the selected column may be moved to the far right of the table (i.e., to the last column of the entire table, as indicated by column Z in the example of FIG. 13).

As shown in FIG. 13, the data of column 84′ of FIG. 12 (i.e., entries E1A, E2A, E3A, and E4A and associated user header H1) have been moved to the right edge of body region 86 in table 80. The entries of the second and third columns of data items in array 80 are moved to the left by one column each. For example, entries E1B, E2B, E3B, and E4B and header H2, which were previously located in column B may be moved to column A and entries E1C, E2C, E3C, and E4C and header H3, which were previously located in column C may be moved to column B.

The use of a tap and flick gesture to move columns such as column 84′ in table 80 may be less burdensome on users than arrangements in which columns are moved by tap and drag gestures. In a table with hundreds or thousands of columns, for example, it may be impractical to move a column with a tap and drag gesture because doing so may consume undesired amounts of power and may be cumbersome or impractical.

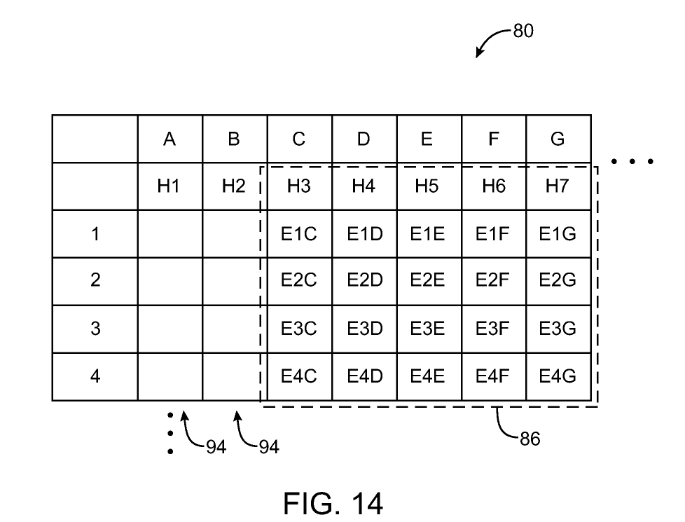

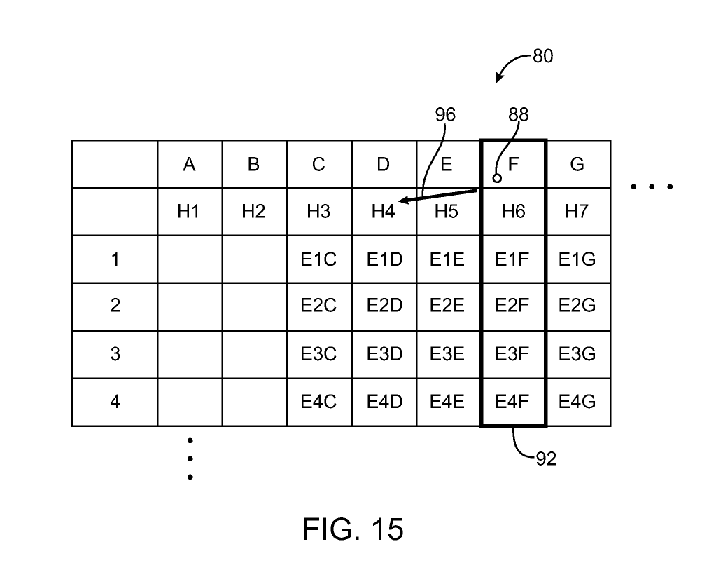

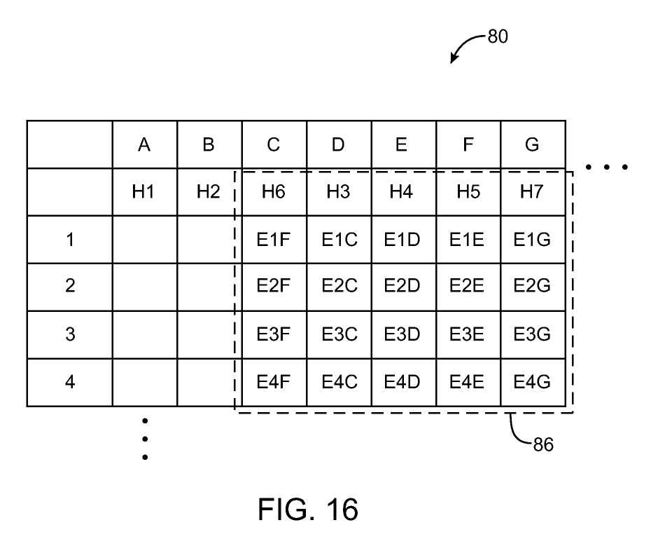

Columns may be moved to the left in table 80 using a tap and left flick gesture. FIG. 14 shows an array in which the body of the array is floating (i.e., there are unfilled (empty) columns 94 to the left of table body region 86). A user may enter a tap gesture (tap 88) on header “F” to select the entries in column F as indicated by highlight region 92 of FIG. 15. Following selection of a desired column (e.g., column F in the FIG. 15 example), the user may make a left flick gesture as indicated by left flick gesture 96. In response, the code (e.g. the spreadsheet application or other code of FIG. 4 on computing equipment 12) may move the selected column to the far left edge of table body region 86, as shown in FIG. 16. The location of body region 86 need not be changed (i.e., the entries of column F from FIG. 15 may be placed in column C in place of the original column C entries and each of the original column entries of columns C, D, and E may each be moved one column to the right (while the column G entries can remain unchanged). The shape of the body region may be determined by the location of data entries without regard to the presence of absence of custom headers such as headers H1, H2, H3 . . . (as an example).

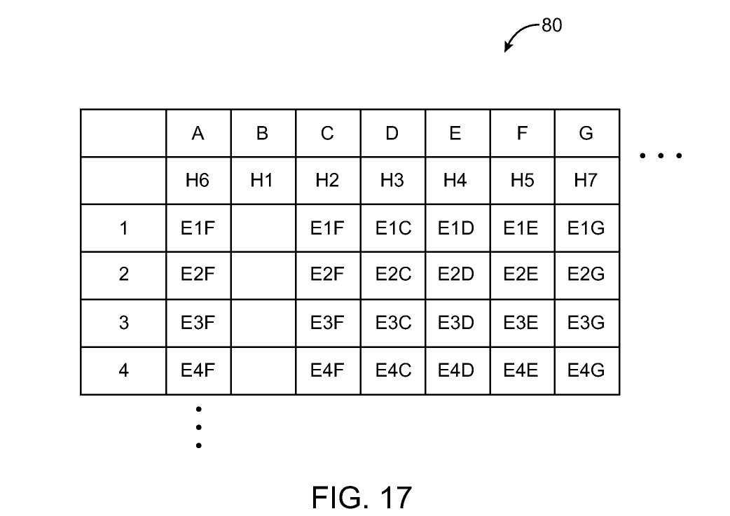

If desired, the entries of the selected column may be moved to the farthest left edge of the spreadsheet or other table structure in which the data is being presented. This type of arrangement is shown in FIG. 17. In the FIG. 17 example, the original columns in the body region of table 80 are unchanged. Only the selected column (originally column F of FIG. 15) has been moved (i.e., to leftmost column position A in the table of FIG. 17, so that empty cells are interposed between the moved column and the table body region). In tables with a finite size (e.g., 1000 columns and rows), a tap and right flick gesture may likewise be used to select a desired column and move that column to the rightmost column of the table, even if the table is only partially filled (i.e., even if the body region contains fewer than 1000 columns of data in a body region that is left justified in table 80). This is illustrated in the example of FIG. 13, which shows how the selected column may be moved to the last table entry (column Z) in response to a tap and right flick.

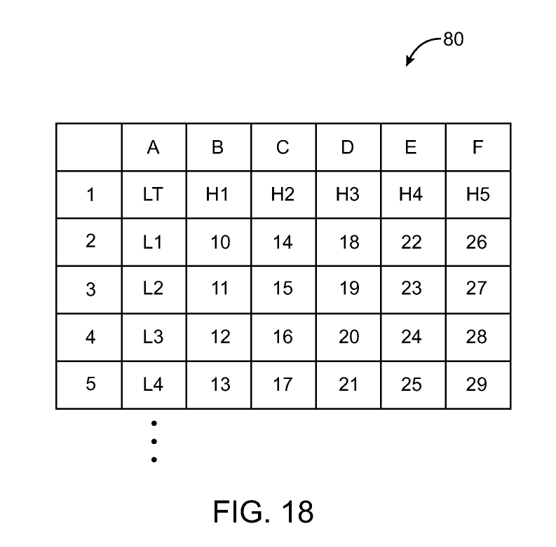

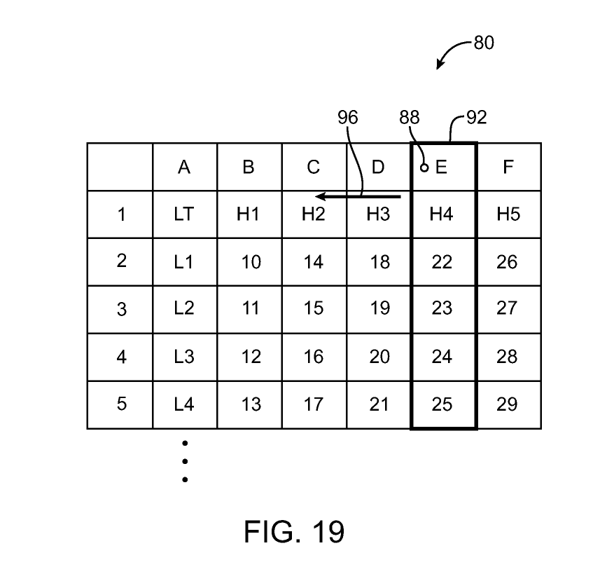

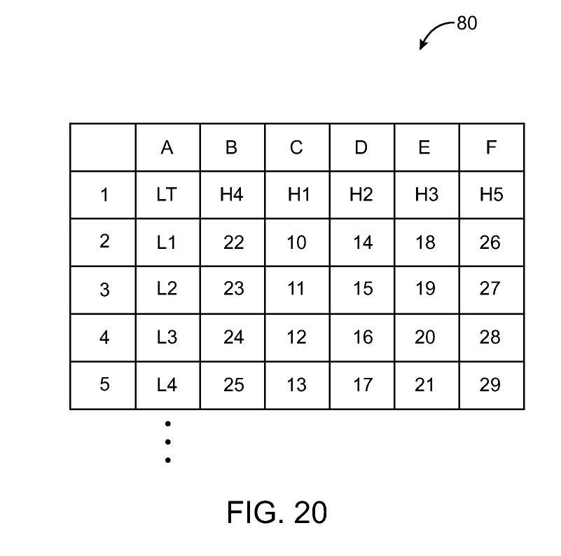

Tables may contain row headers (e.g., “1,” “2,” “3,” etc.) and, with certain table formats, may include user-defined row headers such as row headers L1, L2, L3, and L4 of FIG. 18. In tables of this type, columns that are flicked to the left in the table may be positioned just to the right of the user-defined row headers (i.e., the body region of the table for purposes of column manipulation may be considered to be that portion of the table that lies to the right of the custom row headers). FIG. 19 shows how a user may select a desired column such as column E using tap gesture 88 and may direct computing equipment 12 to move the selected column (i.e., the column highlighted by highlight 92) to the left of the table body using left flick gesture 96. The resulting position of the moved column E entries from FIG. 19 to the immediate right of the user-defined row headers is shown in FIG. 20.

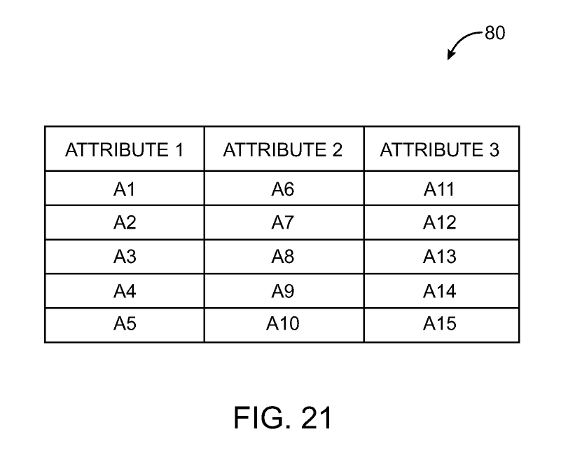

Operating system 52 or other code on computing equipment 12 may be used to present a table of data to a user such as a list of files or other data items each of which contains multiple data attributes. An illustrative table of this type is shown in FIG. 21. Each of the columns of table 80 in FIG. 21 may be associated with different data attributes. The first column may, for example, be associated with a file size data attribute, the second column may, as another example, be associated with a filename attribute, and the third column may be associated with a file type (kind) attribute (as an example). Each row of table 80 may be associated with a different computer file or other data item.

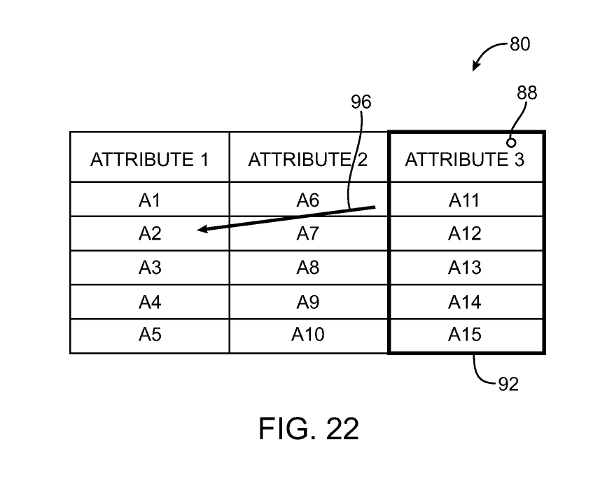

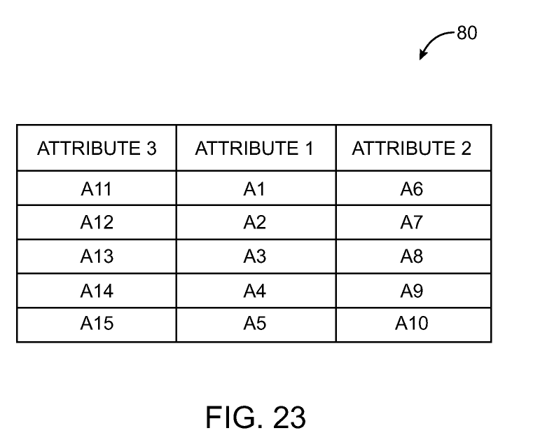

A user may use gestures such as tap and flick gestures to move the columns of table 80 of FIG. 21. For example, a user may select the attribute 3 column by tapping the attribute 3 header as shown by tap 88 and highlight 92 of FIG. 22. The user may then move the highlighted column to the left edge of the table body by making left flick gesture 96. The resulting position of the selected column and its attribute header is shown in FIG. 23. A column in this type of table may be moved to the right using a tap and right flick gesture.

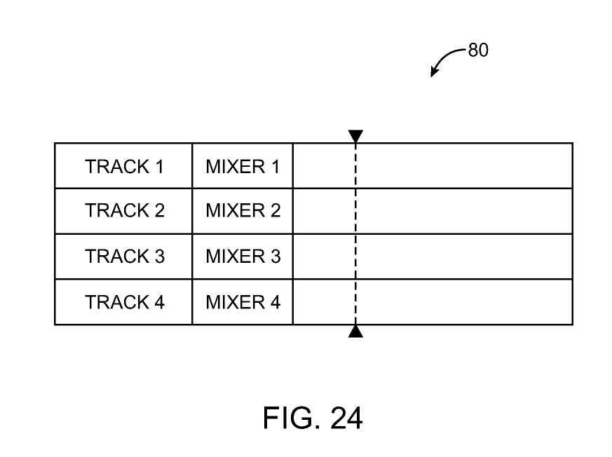

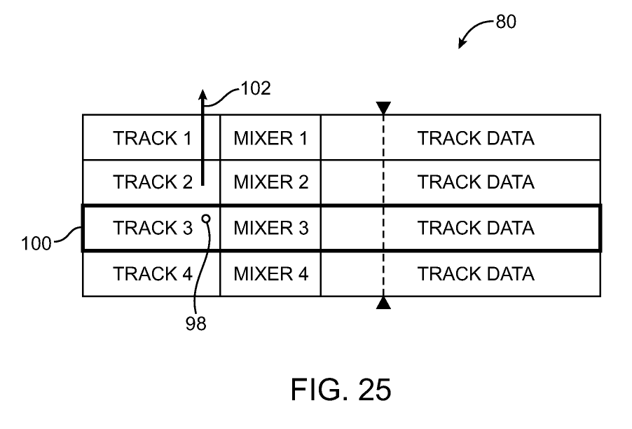

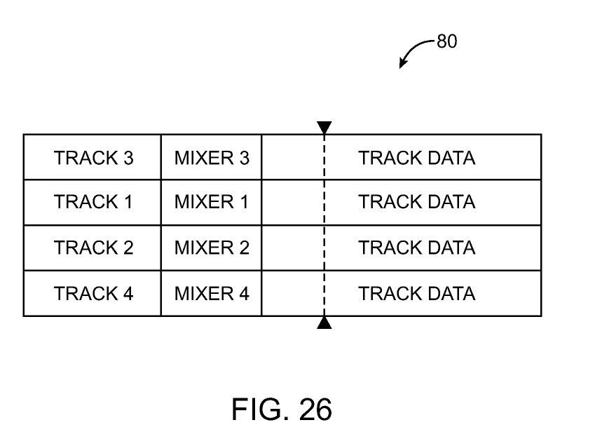

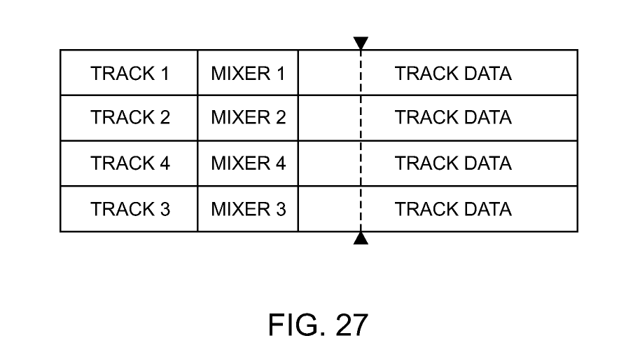

Other software can likewise support gesture-based row and column manipulation functions (e.g., media playback applications, email applications, web applications, etc.). FIG. 24 shows an illustrative table (table 80) that may be presented by media editing code (e.g., a music creation application). As the FIG. 24 example illustrates, table 80 may contain tracks of music data each of which is presented in a corresponding row of table 80. Each track may include data entries such as a track title, instrument name, track number (e.g., a track number header), mixer settings, and song data (e.g., digital audio or musical instrument digital interface data). A user may select a track by tapping on a track number header (or other row header), as indicated by tap 98 in the third row of table 80 in FIG. 25. In response, computing equipment 12 may highlight the selected row of table 80 (using, for example, highlight 100). The user may then move the selected row of table 80 upwards using upwards flick gesture 102. The resulting position of track 3 in the top row of table 100 (i.e., in the uppermost row of the body region portion of table 80) is shown in FIG. 26. The user may move the selected row downwards using a downwards flick, rearranging table 80 to the configuration of FIG. 27.

In any given table 80, taps can be used to select either columns or rows and corresponding flick gestures may be used to move the selected rows or columns (i.e., a selected row may be moved up with an upwards flick or down with a downwards flick and a selected column may be moved right with a right flick or left with a left flick). Rows and columns may be moved to the edge of the body region of the table or, as illustrated in the examples of FIGS. 13 and 17, may be moved further (e.g., to the farthest possible column or row of empty cells in the table such as the leftmost column, rightmost column, uppermost row, or lowermost row). In tables with headers (e.g., user-defined row headers or column headers), a column (or row) may be moved by a left flick (or upwards flick) until adjacent to the headers (see, e.g., the examples of FIGS. 18, 19, and 20 in which the column headed by header H4 is moved to column B adjacent to the headers L1 . . . L4). In general, any of the table manipulations described herein in connection with columns may be performed by equipment 12 in connection with rows and any of the table manipulations that are described herein in connection with rows may be performed by equipment 12 in connection with columns. The use of various flick gestures to manipulate columns (or rows) in the present examples is merely illustrative.

As described in connection with FIG. 6, updates to the structure of table 80 may be maintained in a database (see, e.g., table content 66) by code 62 in response to user gestures. Updated on-screen data or other output 68 may also be presented to the user, so that the user can continue to make changes if needed.

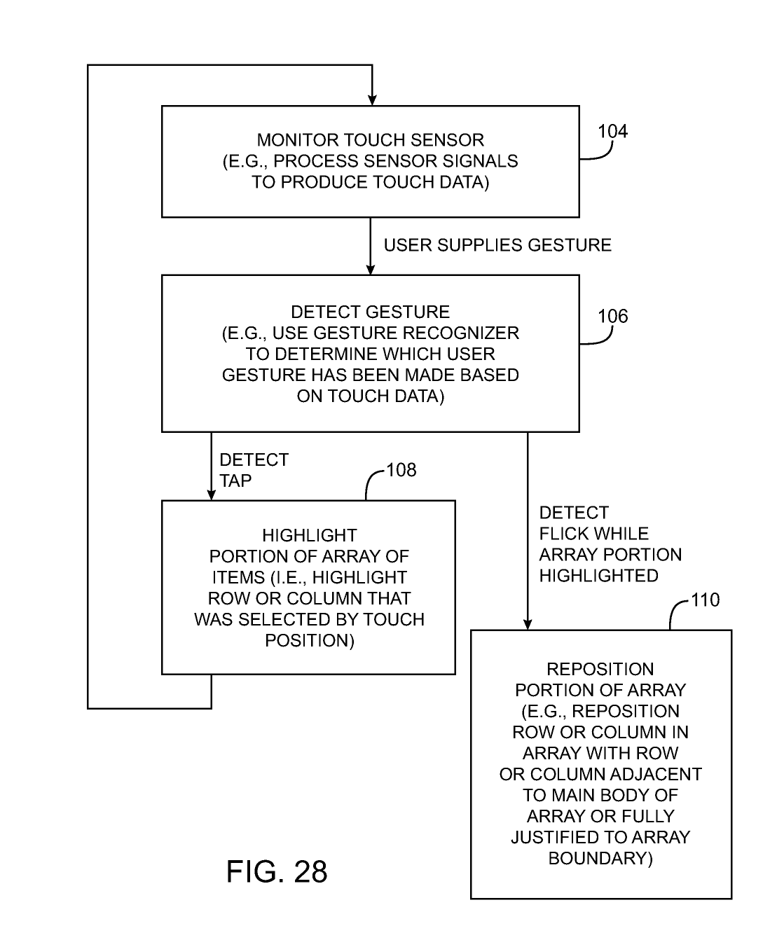

FIG. 28 shows illustrative steps that may be involved in manipulating table data in response to user touch gestures such as tap and flick gestures. The operations of FIG. 28 may be performed by computing equipment 12 (FIG. 1) using localized or distributed code (e.g., locally executed code on a single device or code running in a client-server configuration over a network). Gesture data may be gathered locally (e.g., in the same device that contains the storage and processing circuitry on which the code is executed) or gesture data may be gathered remotely (e.g., with a coupled accessory, a remote client, etc.). Output may be supplied using a local display, local printer, remote display, remote printer, or other suitable input-output devices.

As shown in FIG. 28, a touch sensor array may be used to monitor user input. The touch sensor array may, as an example, be associated with touch screen 30 of FIG. 2. Touch sensor notifier 58 (FIG. 5) or other suitable touch event detection software may be used in gathering touch event data from the touch sensor array and in providing touch event data to gesture recognizer 60. User input may be provided in the form of a single tap gesture on location in a touch sensor array that overlaps a row or column header in a table or other suitable table location to select a row or column for movement and in the form of a single (isolated) flick gesture to move the selected row or column within the table.

When a user enters a gesture, the gesture may be detected by the touch sensor array at step 106 (e.g., capacitance changes may be sensed in an array of capacitive touch sensor electrodes using touch sensor circuitry 53 of FIG. 3, etc.) and appropriate gesture data may be supplied at the output of gesture recognizer 60. Operating system 52, application 54, or other code 62 may receive the gesture data (see, e.g., FIG. 6) and may take appropriate actions (e.g., by adjusting the pattern of image pixels 49 in display 30 that are used to present information to the user). For example, if a tap gesture is detected, code 62 on computing equipment 12 may highlight a row or column of table 80 or otherwise produce a visual representation on display 30 (FIG. 2) to indicate to the user which of the rows or columns of the table has been selected. The tap gesture that is used to direct computing equipment 12 to select and highlight a row or column may be a single tap gesture that contains only a single isolated tap that serves as the exclusive input used by the computing equipment to register a selection (i.e., in isolation, without receiving other gesture input other than the single tap).

Following detecting of a tap gesture during the operations of step 106 and highlighting of a corresponding row or column of the displayed table during the operations of step 108, processing may loop back to steps 104 and 106 to monitor and detect a corresponding flick gesture.

When the user supplies the touch sensor array with a flick gesture (i.e., a single flick gesture that includes only a single isolated flick), code 62 may, at step 110, respond accordingly by manipulating the displayed table on display 30 and by updating the stored version of the table in storage 42.

The operations of step 110 may involve rearranging the body region of the table and potentially moving a row or column to a portion of the table in which empty cells are interposed between the moved row or column and the body portion. For example, the selected row or column may be moved to an appropriate edge of the table body region. A left flick gesture can be used to place a selected column along the left edge of the table body region while repositioning the remaining columns of the table body region as needed (e.g., to ensure that there are no gaps left in the table body region by movement of an interior column). A right flick gesture can be used to move a selected column to the right edge of the table body region. When appropriate (e.g., when a selected column is located in the interior of a table body region and is surrounded on both sides by columns of data in the body region), the columns of the table may be reorganized (e.g., to fill in the gap by moving some of the columns over to the left by one column each). Downwards and upward flicks may be likewise used to reposition rows. With a downwards flick, a selected row may be moved to the lower edge of the table body region. Any gap left in the table by movement of the selected row may be filled in by moving up the rows below the gap. With an upwards flick, a selected row may be moved upwards to the upper edge of the table body region. Any gap that would otherwise remain within the table following an up flick can be effectively removed by moving the rows above the gap downwards by one row each (leaving space for the moved row at the top of the body region). These are examples. In general, any suitable type of column and row repositioning operation may be performed in response to tap and flick gestures if desired.

The foregoing is merely illustrative of the principles of this invention and various modifications can be made by those skilled in the art without departing from the scope and spirit of the invention. The foregoing embodiments may be implemented individually or in any combination.

What is claimed is:

1. Computing equipment, comprising:
a display on which a table of data is displayed;
a touch sensor array that detects touch gestures from a user including tap gestures and flick gestures; and
storage and processing circuitry that is configured to select a row or column of the table of data in response to a detected tap gesture and that is configured to move the selected row or column in response to a detected flick gesture.

2. The computing equipment defined in claim 1 wherein the display and touch sensor array are part of a touch screen, wherein the row or column contains a header and wherein the storage and processing circuitry is configured to select the row or column in response to the detected tap gesture when the detected tap gesture is made on a portion of the touch screen containing the header.

3. The computing equipment defined in claim 2 wherein the tap gesture is a single tap gesture and wherein the storage and processing circuitry is configured to select the row or column in response to the single tap gesture.

4. The computing equipment defined in claim 3 wherein the flick gesture is a single flick gesture and wherein the storage and processing circuitry is configured to move the selected row or column on the display in response to the single flick gesture.

5. The computing equipment defined in claim 4 wherein the storage and processing circuitry is configured to update row and column position data in storage when moving the row or column in response to the single flick gesture.

6. The computing equipment defined in claim 4 wherein the table contains a table body region and empty cells and wherein the storage and processing circuitry is configured to move the selected row or column to an edge of the table body region adjacent to the empty cells in response to the single flick gesture.

7. The computing equipment defined in claim 4 wherein the table contains a table body region and empty cells and wherein the storage and processing circuitry is configured to move the selected row or column to an edge of the table that is different from any edge in the table body region, so that at least some of the empty cells are interposed between the moved row or column and the edge of the table body region.

8. A method, comprising:
with computing equipment, displaying a table of data containing rows and column;
with a touch sensor array in the computing equipment, detecting a tap gesture and a flick gesture supplied by a user; and
in response to detecting the tap gesture, selecting a row or column in the table using the computing equipment; and
in response to detecting the flick gesture, moving the selected row or column within the table using the computing equipment.

9. The method defined in claim 8 wherein displaying the table comprises displaying the table on a touch screen display within the computing equipment and wherein selecting the row or column comprises highlighting the selected row or column on a display in response to detection of the tap gesture.

10. The method defined in claim 9 wherein the table comprises a body region having cells filled with data and comprises empty cells and wherein moving the selected row or column comprises moving data from the body region to an edge portion of the body region adjacent to the empty cells.

11. The method defined in claim 10 wherein the flick gesture comprises a single left flick gesture and wherein moving the selected row or column comprises moving a selected column to a left edge of the body region.

12. The method defined in claim 11 wherein the flick gesture comprises a downwards flick gesture and wherein moving the selected row or column comprises moving a selected row to a lower edge of the body region.

13. The method defined in claim 10 wherein moving the selected row or column comprises moving the selected row or column in response to a single flick gesture selected from the group of flick gestures consisting of: a left flick, a right flick, an upwards flick, and a downwards flick.

14. The method defined in claim 9 wherein moving the selected row or column comprises updating row or column position information in storage in response to the detected flick gesture.

15. The method defined in claim 14 wherein the storage is located at a server and wherein updating the row or column position information comprises transmitting updated row or column position information from a client to a server over a communications network.

16. The method defined in claim 9 wherein displaying the table comprises displaying the table on the touch screen display with a spreadsheet application implemented on the computing equipment and wherein moving the selected row or column comprises updating a database using the spreadsheet application.

17. The method defined in claim 9 wherein displaying the table comprises displaying the table on the touch screen display with an operating system implemented on the computing equipment and wherein moving the selected row or column comprises moving a column associated with a particular data attribute using the operating system.

18. The method defined in claim 9 wherein displaying the table comprises displaying the table on the touch screen display with a music creation application implemented on the computing equipment and wherein moving the selected row or column comprises moving a selected track between rows in the table using the music creation application.

19. Computing equipment, comprising:
a touch screen display that contains a touch sensor; and
storage and processing circuitry with which a table of data is displayed on the touch screen display, wherein the storage and processing circuitry is configured to detect touch gestures using the touch sensor and is configured to rearrange the table of data in response to detection of a tap and flick gesture.

20. The computing equipment defined in claim 19 wherein the tap and flick gesture comprises a single tap on a header in the table that selects a portion of the table for movement and wherein the tap and flick gesture comprises a single isolated flick in a direction that indicates which direction to move the selected portion of the table.

21. The computing equipment defined in claim 20 wherein the selected portion comprises a selected row or column of the table, wherein the storage and processing circuitry is configured to highlight the selected row or column in response to detection of the tap on the header, and wherein the storage and processing circuitry is configured to display a manipulated version of the table of data on the touch screen display in response to detection of the flick gesture.
